(19) United States
(12) Patent Application Publication
(10) Pub. No.: US 2010/0007553 A1
(43) Pub. Date: Jan. 14, 2010

(54) APPARATUS AND METHOD FOR SHARING ASSISTANCE DATA BETWEEN A-GPS TERMINAL AND GPS TERMINAL

(75) Inventors: Jin-Yup KIM, Yongin-si (KR); Seung-Yoon LEE, Suwon-si (KR); Jong-Mu CHOI, Gunpo-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/499,316

(22) Filed: Jul. 8, 2009

(30) Foreign Application Priority Data
Jul. 8, 2008 (KR) 10-2008-0065970

(51) Int. Cl. G01S 5/14

(52) U.S. Cl. 342/357.09

(57) ABSTRACT

An apparatus and method for sharing assistance data between an Assisted Global Positioning System (A-GPS) terminal and a Global Positioning System (GPS) terminal are provided. The method includes establishing a connection with an A-GPS terminal, transmitting an assistance data request message to the A-GPS terminal, receiving an assistance data response message including assistance data from the A-GPS terminal, and performing position determination by using the assistance data and GPS position information received from a GPS artificial satellite. Accordingly, position determination can be achieved faster.

### PRIORITY

This application claims the benefit under 35 U.S.C. § 119(a) of a Korean patent application filed in the Korean Intellectual Property Office on Jul. 8, 2008 and assigned Serial No. 10-2008-0065970, the entire disclosure of which is hereby incorporated by reference.

### BACKGROUND OF THE INVENTION

1. Field of the Invention

The present invention relates to an apparatus and method for sharing assistance data between an Assisted Global Positioning System (A-GPS) terminal and a Global Positioning System (GPS) terminal. More particularly, the present invention relates to an apparatus and method in which a GPS terminal requests an A-GPS terminal to transmit assistance data and uses the received assistance data to perform position determination faster.

2. Description of the Related Art

A Global Positioning System (GPS) is a system capable of performing position determination in various places around the world by using 24 GPS satellites orbiting the Earth at an altitude of about 20,000 km. The GPS uses radio waves with a band of 1.5 GHz. A control center, which is a control station on the ground, collects information transmitted from GPS satellites, and synchronizes a transmission time. A user can recognize its current position by using a GPS receiver. Trigonometric measurement is commonly used by the GPS for position determination. Three satellites are necessary for the trigonometric measurement. In addition thereto, one observatory satellite is necessary to correct a time error. Therefore, four satellites in total are necessary for position determination.

Due to multiple paths or lack of visible satellites, the ability of position determination is limited in a downtown area where a large number of skyscrapers are located. Further, correct position determination is almost impossible in a place where signals from satellites cannot be received (i.e., a place where radio waves are unreceivable), such as in a tunnel or an underground building. Occasionally, a Time To First Fix (TTFF), which is an actual amount of time required when the GPS receiver determines its own position for the first time, may be approximately several minutes to 10 minutes or more. The amount of time leads to significant inconvenience for users who use a location-based wireless Internet service.

A disadvantage of the GPS scheme can be compensated for by using an Assisted Global Positioning System (A-GPS) scheme which combines the GPS scheme with resources of a mobile network to determine a position of a mobile communication terminal. According to the A-GPS scheme, the mobile communication terminal collects information necessary for position determination from a GPS artificial satellite and a wireless network at the same time. Thus, the mobile communication terminal can achieve three-dimensional positioning by using latitude, longitude and altitude coordinates. In this case, the wireless network and the mobile communication terminal transmit and receive data or messages by using parameters defined in an Interim Standard (IS)-801-1 standard.

Information necessary for position determination and collected from the wireless network is referred to as assistance data. The assistance data includes a reference time, a reference location, a Differential GPS (DGPS) correction value, a visible Satellite Vehicle (SV) list, sensitivity, a navigation model, an ionosphere model, a Universal Time Coordinated (UTC) model, almanac/ephemeris, acquisition assistance, real-time integrity, and the like. By using the assistance data provided from the wireless network, the mobile communication terminal can determine positions faster, and can also determine positions in a shadow area.

However, a problem exists in that a mobile communication terminal not supporting the A-GPS cannot use the assistance data. Thus, the mobile communication terminal cannot determine positions faster.

Therefore, a need exists for an apparatus and method for determining positions faster by using assistance data.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for sharing assistance data between an Assisted Global Positioning System (A-GPS) terminal and a Global Positioning System (GPS) terminal.

Another aspect of the present invention is to provide an apparatus and method in which a GPS terminal requests an A-GPS terminal to transmit assistance data and uses the received assistance data to perform position determination faster.

In accordance with an aspect of the present invention, a method for position determination of a GPS terminal is provided. The method includes establishing a connection with an A-GPS terminal, transmitting an assistance data request message to the A-GPS terminal, receiving an assistance data response message including assistance data from the A-GPS terminal, and performing position determination by using the assistance data and GPS position information received from a GPS artificial satellite.

In accordance with another aspect of the present invention, a method for transmitting assistance data of an A-GPS terminal is provided. The method includes establishing a connection with a GPS terminal, receiving an assistance data request message from the GPS terminal, and transmitting an assistance data response message including assistance data to the GPS terminal.

In accordance with still another aspect of the present invention, an apparatus for position determination of a GPS terminal is provided. The apparatus includes an assistance data acquisition unit for establishing a connection with an A-GPS terminal, for transmitting an assistance data request message to the A-GPS terminal, and for receiving an assistance data response message including assistance data from the A-GPS terminal, a GPS position information acquisition unit for receiving GPS position information from a GPS artificial satellite, and a position determination unit for performing position determination by using the assistance data and the GPS position information.

In accordance with yet another aspect of the present invention, an apparatus for transmitting assistance data of an A-GPS terminal is provided. The apparatus includes an assistance data acquisition unit for obtaining assistance data by transmitting an assistance data request message to a Service Mobile Location Center (SMLC) and by receiving an assistance data response message from the SMLC, for establishing a connection with a GPS terminal, and upon receiving the assistance data request message from the GPS terminal, for transmitting an assistance data response message including the obtained assistance data to the GPS terminal, a GPS position information acquisition unit for receiving GPS position information from a GPS artificial satellite, and a position determination unit for performing position determination by using the assistance data and the GPS position information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a network environment according to an exemplary embodiment of the present invention;

FIG. 2 is a block diagram illustrating a structure of a Global Positioning System (GPS) terminal according to an exemplary embodiment of the present invention;

FIG. 3 is a signal flow diagram illustrating a method for sharing assistance data between an Assisted Global Positioning System (A-GPS) terminal and a GPS terminal when the A-GPS terminal includes the assistance data according to an exemplary embodiment of the present invention;

FIG. 4 is a signal flow diagram illustrating a method for sharing assistance data between an A-GPS terminal and a GPS terminal when the A-GPS terminal does not include the assistance data according to an exemplary embodiment of the present invention;

FIG. 5 is a flowchart illustrating a method for position determination in which a GPS terminal receives assistance data from an A-GPS terminal and determines a position by using the received assistance data according to an exemplary embodiment of the present invention; and

FIG. 6 is a flowchart illustrating a method for transmitting assistance data to a GPS terminal by an A-GPS terminal at the request of the GPS terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention described below provide an apparatus and method in which a Global Positioning System (GPS) terminal requests an Assisted Global Positioning System (A-GPS) terminal to transmit assistance data and uses the received assistance data to perform position determination faster.

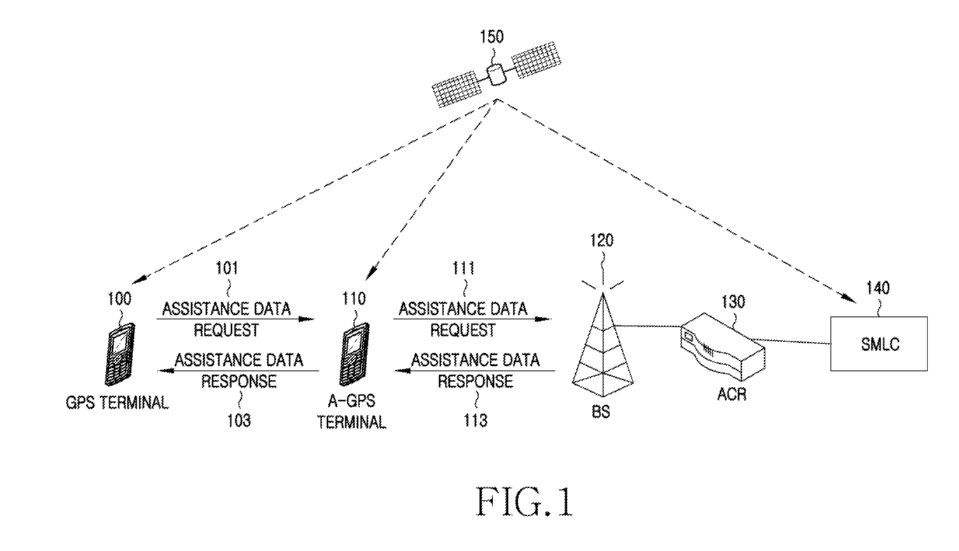

FIG. 1 illustrates a network environment according to an exemplary embodiment of the present invention.

Referring to FIG. 1, a GPS terminal 100 and an A-GPS terminal 110, each including a GPS receiver or connected to the GPS receiver, gather information necessary for position determination from a GPS artificial satellite 150 and determine the GPS receiver positions by using the gathered information. The GPS terminal 100 and the A-GPS terminal 110 then provide a service of reporting the positions to users. The A-GPS terminal 110 is differentiated from the GPS terminal 100 in that the A-GPS terminal 110 gathers information necessary for position determination from the GPS artificial satellite 150 and a wireless network at the same time. The information necessary for position determination and the information gathered from the wireless network are referred to as assistance data. That is, the A-GPS terminal 110 transmits an assistance data request message to a Serving Mobile Location Center (SMLC) 140 via a Base Station (BS) 120 and a Access Control Router (ACR) 130 to request the SMLC 140 to transmit assistance data in step 111, and receives an assistance data response message including the assistance data from the SMLC 140 via the ACR 130 and the BS 120 in step 113. Thus, the A-GPS terminal 110 may gather the assistance data.

In an exemplary implementation, the GPS terminal 100 may also gather the assistance data and may use the assistance data for position determination. That is, the GPS terminal 100 transmits an assistance data request message to the A-GPS terminal 110 to request transmission of the assistance data in step 101, and receives an assistance data response message including the assistance data from the A-GPS terminal 110 in step 103. Thus, the GPS terminal 100 may gather the assistance data. In this case, the A-GPS terminal 110 may store assistance data previously received from the SMLC 140 in a storage unit and may manage the assistance data. When transmission of the assistance data is requested by the GPS terminal 100, the A-GPS terminal 110 may extract the assistance data from the storage unit and then transmit the assistance data. If assistance data is not previously received from the SMLC 140, the A-GPS terminal 110 may request the SMLC 140 to transmit assistance data. The A-GPS terminal 110 then may transmit the assistance data to the GPS terminal 100 by performing a process of receiving the assistance data.

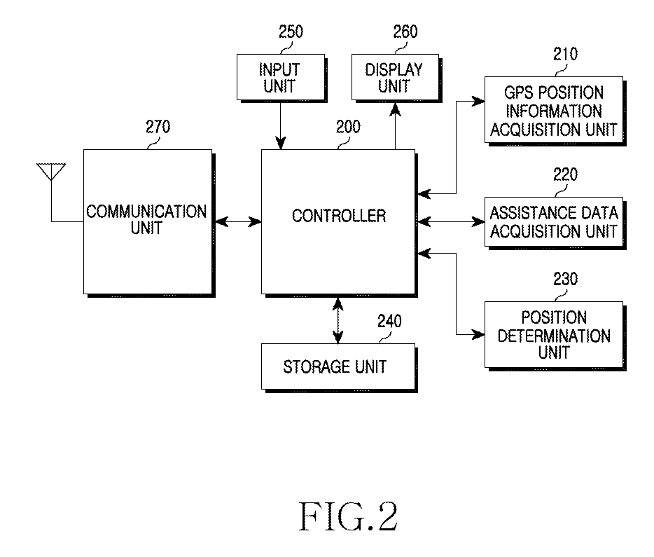

FIG. 2 is a block diagram illustrating a structure of a GPS terminal according to an exemplary embodiment of the present invention.

Referring to FIG. 2, the GPS terminal includes a controller 200, a GPS position information acquisition unit 210, an assistance data acquisition unit 220, a position determination unit 230, a storage unit 240, an input unit 250, a display unit 260 and a communication unit 270.

The controller 200 controls and processes overall operations of the GPS terminal. More particularly, the controller 200 requests an A-GPS terminal to transmit assistance data, and then uses the received assistance data to control and process a function for performing position determination faster.

The GPS position information acquisition unit 210 includes a GPS receiver or is connected to the GPS receiver. Thus, the GPS position information acquisition unit 210 obtains GPS position information necessary for position determination from a GPS artificial satellite.

The assistance data acquisition unit 220 requests the A-GPS terminal to transmit the assistance data, and then receives the assistance data from the A-GPS terminal, thereby obtaining the assistance data necessary for position determination.

The position determination unit 230 receives the GPS position information necessary for position determination and the assistance data from the GPS position information acquisition unit 210 and the assistance data acquisition unit 220. The position determination unit 230 then determines a position by using the received GPS position information and assistance data.

The storage unit 240 stores programs used for overall operations of the GPS terminal and a variety of information. More particularly, the storage unit 240 stores and manages the GPS position information and the assistance data obtained by the GPS position information acquisition unit 210 and the assistance data acquisition unit 220.

The input unit 250 includes a plurality of function keys to provide the controller 200 with data corresponding to a key pressed by a user.

The display unit 260 displays state information, numeric characters, alphabetic characters, and the like which are generated during the operation of the GPS terminal.

The communication unit 270 processes a signal transmitted and received through an antenna.

The A-GPS terminal has the same structure as the GPS terminal. However, an assistance data acquisition unit of the A-GPS terminal requests an SMLC to transmit assistance data and then receives the assistance data from the SMLC. Thus, the assistance data acquisition unit of the A-CPS terminal obtains the assistance data necessary for position determination. In addition, when transmission of the assistance data is requested by the GPS terminal, the assistance data acquisition unit of the A-GPS terminal extracts assistance data, which is previously received from the SMLC, from a storage unit. If no assistance data is previously received from the SMLC, the assistance data acquisition unit of the A-GPS terminal requests the SMLC to transmit the assistance data and then transmits the assistance data to the GPS terminal by performing a process for receiving the assistance data.

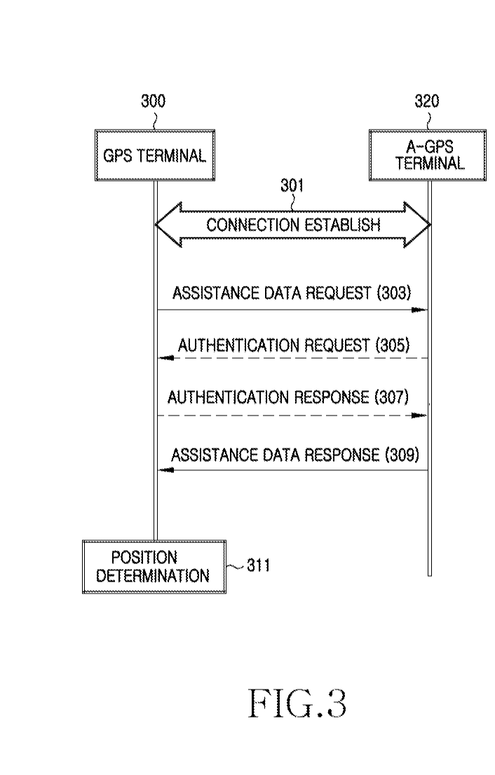

FIG. 3 is a signal flow diagram illustrating a method for sharing assistance data between an A-GPS terminal and a GPS terminal when the A-GPS terminal includes the assistance data according to an exemplary embodiment of the present invention.

Referring to FIG. 3, a GPS terminal 300 establishes a connection with an A-GPS terminal 320 in step 301. The connection includes wired/wireless connections. For example, the connection with the A-GPS terminal 320 may be established using a Universal Serial Bus (USB), an Infrared Data Association (IrDA), Bluetooth, WiFi, Wireless Local Area Network (WLAN), a Short Message Service (SMS), and the like.

In step 303, the GPS terminal 300 transmits an assistance data request message to the A-GPS terminal 320 to request transmission of assistance data. In step 305, the A-GPS terminal 320 transmits an authentication request message to the GPS terminal 300 to request transmission of authentication data. If the authentication data is received using an authentication response message from the GPS terminal 300 in step 307, the A-GPS terminal 320 uses the received authentication data to perform a user authentication process for determining whether a user of the GPS terminal 300 is an authenticated user for a service. After completion of the user authentication, the A-GPS terminal 320 extracts assistance data from a storage unit. In step 309, the A-GPS terminal 320 transmits an assistance data response message including the extracted assistance data to the GPS terminal 300. In this case, the GPS terminal 300 may transmit to the A-GPS terminal 320 an assistance data ACKnowledgement (ACK) message for reporting successful reception of the assistance data.

In step 311, the GPS terminal 300 performs position determination by using the assistance data received from the A-GPS terminal 320 and GPS position information received from a GPS artificial satellite.

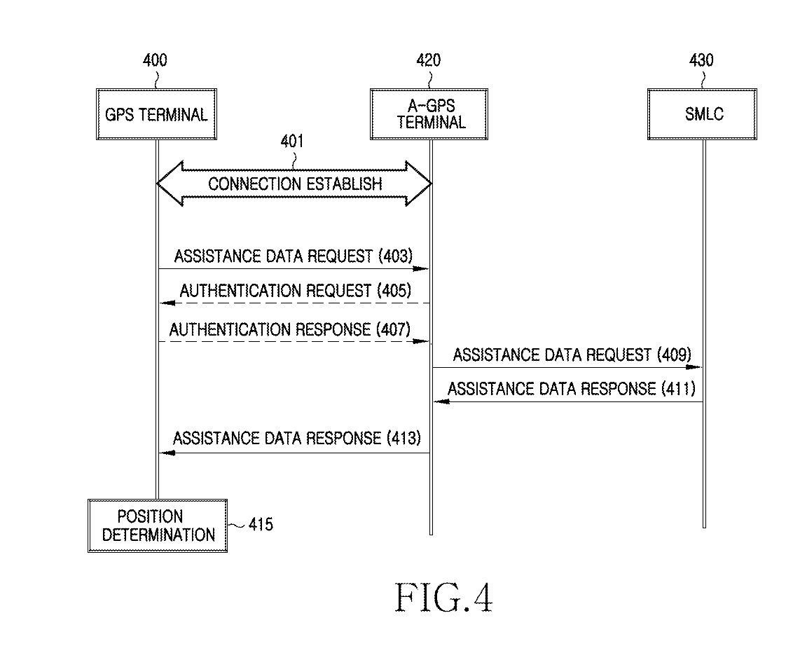

FIG. 4 is a signal flow diagram illustrating a method for sharing assistance data between an A-GPS terminal and a GPS terminal when the A-GPS terminal does not include the assistance data according to an exemplary embodiment of the present invention.

Referring to FIG. 4, the same procedure of FIG. 3 is illustrated except that assistance data is not stored in a storage unit of an A-GPS terminal 420. Thus, an additional process is necessary to receive the assistance data by requesting an SMLC 430 to transmit the assistance data. That is, when the A-GPS terminal 420 is connected to a GPS terminal 400 in step 401, according to an assistance data request of the GPS terminal 400 in step 403, the A-GPS terminal 420 performs a user authentication process on the GPS terminal 400 in steps 405 and 407. Upon completion of the user authentication process, the A-GPS terminal 420 transmits an assistance data request message to the SMLC 430 to request transmission of the assistance data in step 409. In step 411, the A-GPS terminal 420 receives an assistance data response message including the assistance data from the SMLC 430. In step 413, the A-GPS terminal 420 transmits the received assistance data response message to the GPS terminal 400. In step 415, the GPS terminal 400 performs position determination by using the assistance data received from the A-GPS terminal 420 and GPS position information received from a GPS artificial satellite.

Additionally, the GPS terminal 400 may transmit to the A-GPS terminal 420 an assistance data ACK message for reporting successful reception of the assistance data to the A-GPS terminal 420. Upon receiving the assistance data ACK message, the A-GPS terminal 420 may deliver the received message. In this case, the assistance data ACK message transmitted by the A-GPS terminal 420 to the SMLC 430 may be transmitted to the SMLC 430 upon receiving the assistance data ACK message from the GPS terminal 400, or may be transmitted by the A-GPS terminal 420 directly to the SMLC 430 upon confirming successful reception of the assistance data response message from the A-GPS terminal 420.

In addition, upon receiving the assistance data ACK message, the SMLC 430 may transmit a measure position request message to the A-GPS terminal 420 to request position determination. Upon receiving the measure position request message, the A-GPS terminal 420 may measure a position by using the received assistance data and may transmit a measure position response message including information on the measured position to the SMLC 430. In this case, the SMLC 430 may update a database by using position information of the A-GPS terminal 420.

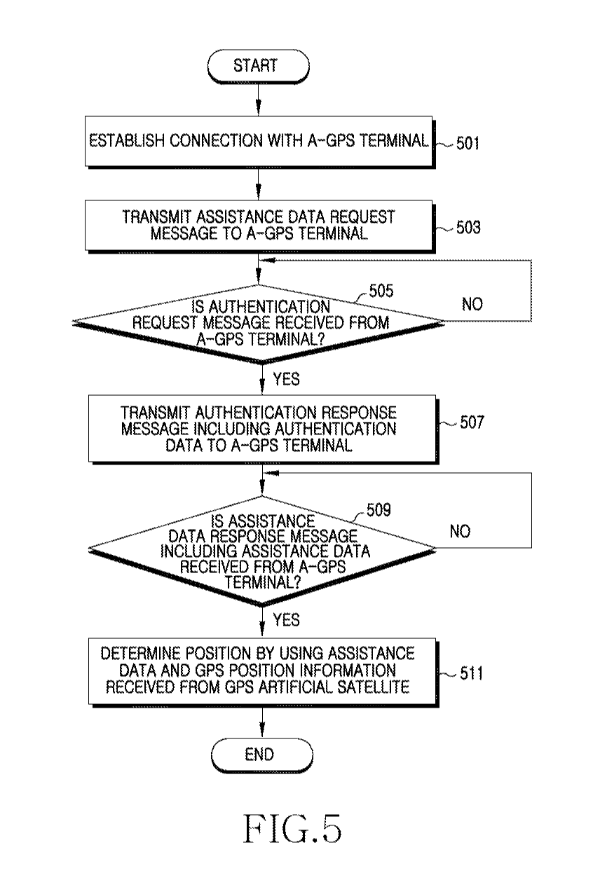

FIG. 5 is a flowchart illustrating a method for position determination in which a GPS terminal receives assistance data from an A-GPS terminal and determines a position by using the received assistance data according to an exemplary embodiment of the present invention.

Referring to FIG. 5, the GPS terminal establishes a connection with the A-GPS terminal in step 501, and then transmits an assistance data request message to the A-GPS terminal to request transmission of assistance data in step 503.

In step 505, the GPS terminal determines whether an authentication request message for requesting transmission of authentication data is received from the A-GPS terminal. Upon receiving the authentication request message, the GPS terminal transmits an authentication response message including the assistance data to the A-GPS terminal in step 507.

In step 509, the GPS terminal determines whether an assistance data response message including the assistance data is received from the A-GPS terminal. Upon receiving the assistance data response message, the GPS terminal determines its position by using the assistance data and GPS position information received from a GPS artificial satellite in step 511.

Thereafter, the procedure of FIG. 5 ends.

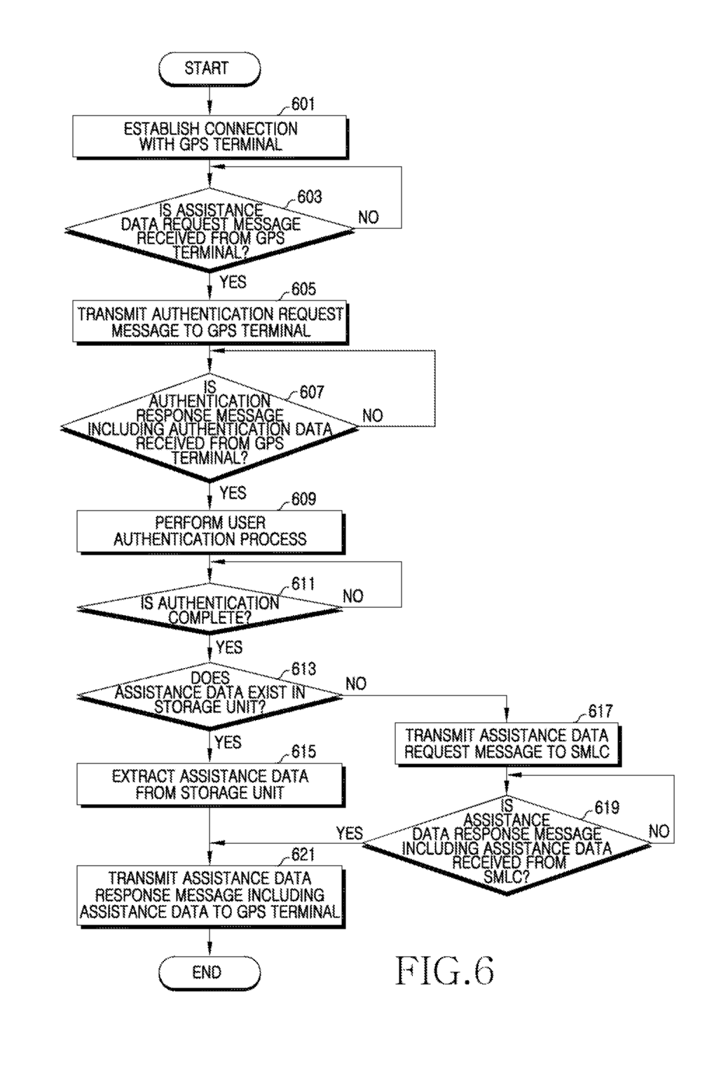

FIG. 6 is a flowchart illustrating a method for transmitting assistance data to a GPS terminal by an A-GPS terminal at the request of the GPS terminal according to an exemplary embodiment of the present invention.

Referring to FIG. 6, the A-GPS terminal establishes a connection with the GPS terminal in step 601, and determines whether an assistance data request message for requesting transmission of assistance data is received from the GPS terminal in step 603.

Upon receiving the assistance data request message, the A-GPS terminal transmits an authentication request message for requesting transmission of authentication data to the GPS terminal in step 605. The A-GPS terminal then determines whether an authentication response message including the authentication data is received from the GPS terminal in step 607.

Upon receiving the authentication response message, the A-GPS terminal performs a user authentication process for determining whether a user of the GPS terminal is an authenticated user for a service in step 609. The A-GPS terminal then determines whether the user authentication process is complete in step 611.

Upon completion of the user authentication process, in step 613, the A-GPS terminal determines whether assistance data previously received from an SMLC exists in a storage unit. If the assistance data exists in the storage unit, the A-GPS terminal extracts the assistance data from the storage unit in step 615, and transmits an assistance data response message including the extracted assistance data to the GPS terminal in step 621.

Otherwise, if the assistance data is not included in the storage unit, the A-GPS terminal transmits the assistance data request message to the SMLC in step 617. In step 619, the A-GPS terminal determines whether an assistance data response message including the assistance data is received from the SMLC. Upon receiving the assistance data response message, in step 621, the A-GPS terminal transmits the received assistance data response message to the GPS terminal.

Thereafter, the procedure of FIG. 6 ends.

The assistance data may be subjected to Digital Right Management (DRM) or encryption/decryption. Further, an accounting rule may be used between the GPS terminal and the A-GPS terminal to establish free or charged payment.

According to exemplary embodiments of the present invention, a GPS terminal requests an A-GPS terminal to transmit assistance data. By using the requested assistance data, position determination may be achieved faster and a user of the GPS terminal may receive position information faster. The user of the GPS terminal may also receive position information when entering a shadow area.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for position determination of a Global Positioning System (GPS) terminal, the method comprising:
establishing a connection with an Assisted Global Positioning System (A-GPS) terminal;
transmitting an assistance data request message to the A-GPS terminal;
receiving an assistance data response message including assistance data from the A-GPS terminal; and
performing position determination by using the assistance data and GPS position information received from a GPS artificial satellite.

2. The method of claim 1, wherein the connection with the A-GPS terminal is established using one of a Universal Serial Bus (USB), an Infrared Data Association (IrDA), Bluetooth, WiFi, Wireless Local Area Network (WLAN) and a Short Message Service (SMS).

3. The method of claim 1, further comprising:
after transmitting the assistance data request message, receiving an authentication request message from the A-GPS terminal; and
transmitting an authentication response message including authentication data to the A-GPS terminal.

4. The method of claim 1, wherein, upon receiving the assistance data response message, transmitting an assistance data ACKnowledgement (ACK) message to the A-GPS terminal.

5. A method for transmitting assistance data of an Assisted Global Positioning System (A-GPS) terminal, the method comprising:
establishing a connection with a Global Positioning System (GPS) terminal;
receiving an assistance data request message from the GPS terminal; and
transmitting an assistance data response message including assistance data to the GPS terminal.

6. The method of claim 5, further comprising:
determining whether assistance data exists in a storage unit upon receiving the assistance data request message;
if the assistance data exists in the storage unit, extracting the assistance data from the storage unit; and
if the assistance data does not exist in the storage unit, transmitting the assistance data request message to a Service Mobile Location Center (SMLC), and receiving an assistance data response message including the assistance data from the SMLC,
wherein one of the extracted assistance data and the assistance data received from the SMLC comprises the assistance data included in the assistance data response message and transmitted to the GPS terminal.

7. The method of claim 5, wherein the connection with the GPS terminal is established using one of a Universal Serial Bus (USB), an Infrared Data Association (IrDA), Bluetooth, WiFi, Wireless Local Area Network (WLAN) and a Short Message Service (SMS).

8. The method of claim 5, further comprising:
after receiving the assistance data request message, transmitting an authentication request message to the GPS terminal;
receiving an authentication response message including authentication data from the GPS terminal; and
performing a user authentication process on the GPS terminal by using the authentication data,
wherein the transmitting of the assistance data response message to the GPS terminal is performed when the user authentication process is successfully performed.

9. An apparatus for position determination of a Global Positioning System (GPS) terminal, the apparatus comprising:
an assistance data acquisition unit for establishing a connection with an Assisted Global Positioning System (A-GPS) terminal, for transmitting an assistance data request message to the A-GPS terminal, and for receiving an assistance data response message including assistance data from the A-GPS terminal;
a GPS position information acquisition unit for receiving GPS position information from a GPS artificial satellite; and
a position determination unit for performing position determination by using the assistance data and the GPS position information.

10. The apparatus of claim 9, wherein the connection with the A-GPS terminal is established using one of a Universal Serial Bus (USB), an Infrared Data Association (IrDA), Bluetooth, WiFi, Wireless Local Area Network (WLAN) and a Short Message Service (SMS).

11. The apparatus of claim 9, wherein the assistance data acquisition unit receives an authentication request message from the A-GPS terminal after the assistance data request message is transmitted, and transmits an authentication response message including authentication data to the A-GPS terminal.

12. The apparatus of claim 9, wherein the assistance data acquisition unit transmits an assistance data ACKnowledgment (ACK) message to the A-GPS terminal upon receiving the assistance data response message.

13. An apparatus for transmitting assistance data of an Assisted Global Positioning System (A-GPS) terminal, the apparatus comprising:
an assistance data acquisition unit for obtaining assistance data by transmitting an assistance data request message to a Service Mobile Location Center (SMLC) and by receiving an assistance data response message from the SMLC, for establishing a connection with a Global Positioning System (GPS) terminal, and upon receiving the assistance data request message from the GPS terminal, for transmitting an assistance data response message including the obtained assistance data to the GPS terminal;
a GPS position information acquisition unit for receiving GPS position information from a GPS artificial satellite; and
a position determination unit for performing position determination by using the assistance data and the GPS position information.

14. The apparatus of claim 13, wherein the assistance data acquisition unit determines whether assistance data exists in a storage unit upon receiving the assistance data request message from the GPS terminal, if the assistance data exists in the storage unit, extracts the assistance data from the storage unit, and if the assistance data does not exist in the storage unit, transmits the assistance data request message to a Service Mobile Location Center (SMLC) and receives an assistance data response message including the assistance data from the SMLC.

15. The apparatus of claim 13, wherein the connection with the GPS terminal is established using one of a Universal Serial Bus (USB), an Infrared Data Association (IrDA), Bluetooth, WiFi, Wireless Local Area Network (WLAN) and a Short Message Service (SMS).

16. The apparatus of claim 13, wherein the assistance data acquisition unit transmits an authentication request message to the GPS terminal after the assistance data request message is received, performs a user authentication process on the GPS terminal by using the authentication data upon receiving an authentication response message including authentication data from the GPS terminal, and transmits the assistance data response message to the GPS terminal when the user authentication process is successfully performed.
